(19) United States
(12) Patent Application Publication
(10) Pub. No.: US 2011/0013072 A1
(43) Pub. Date: Jan. 20, 2011

(54) METHOD AND APPARATUS FOR MANUAL FOCUSING IN PORTABLE TERMINAL

(75) Inventor: Young-Keun CHOI, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/836,074

(22) Filed: Jul. 14, 2010

(30) Foreign Application Priority Data
Jul. 14, 2009 (KR) 10-2009-0063792

(51) Int. Cl. H04N 5/232; G06F 3/041

(52) U.S. Cl. 348/345; 345/173; 348/E05.045

(57) ABSTRACT

A method and apparatus for manual focusing in a portable terminal are provided. The method includes providing a user interface for determining a focusing area and a focusing level to a screen, determining the focusing area according to a motion of touching the screen, determining the focusing level according to the motion of touching the screen, and performing focusing on the determined focusing area according to the determined focusing level.

### PRIORITY

This application claims the benefit under 35 U.S.C. §119(a) of a Korean patent application filed in the Korean Intellectual Property Office on Jul. 14, 2009 and assigned Serial No. 10-2009-0063792, the entire disclosure of which is hereby incorporated by reference.

### BACKGROUND OF THE INVENTION

1. Field of the Invention

The present invention relates to a method and apparatus for manual focusing in a portable terminal. More particularly, the present invention relates to a method and apparatus for performing manual focusing by using a touch screen.

2. Description of the Related Art

Portable terminals began as simple portable information devices. However, with the development of communication technologies and various related techniques, portable terminals now provide a variety of functions, such as voice and video telephony, digital cameras, digital multimedia broadcasting, games, etc. In particular, a digital camera function with high-pixel resolution is provided in recently developed portable terminals due to growing interest in photography.

Digital cameras equipped in portable terminals provide an auto-focusing mechanism which automatically adjusts a screen focus. The auto-focusing mechanism automatically adjusts a focus of an image input through a camera when a capture event occurs. The auto-focusing mechanism is a useful function for users who find it difficult to correctly adjust a focus of a camera. However, this function acts as a disadvantage for those who want to capture a desired image by minutely adjusting a focusing level. Of course, a manual focusing mechanism for minutely adjusting a focusing level by moving a lens body tube has conventionally been provided. It is difficult to apply this mechanism to a compact portable terminal. A typical portable terminal has a limited size, which leads to a problem in that it is difficult to add a physical apparatus or key for the manual focusing as in the case of using the conventional mechanism. In addition, the conventional focusing mechanisms have a disadvantage in that it is difficult to determine a region for performing focusing according to a user's intention.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for manual focusing in a portable terminal.

Another aspect of the present invention is to provide a method and apparatus for performing manual focusing by using a touch screen in a portable terminal.

Another aspect of the present invention is to provide a method and apparatus for determining a focusing area and for controlling a focusing level by using a touch screen in a portable terminal.

In accordance with an aspect of the present invention, a method of manual focusing in a portable terminal is provided. The method includes providing a user interface for determining a focusing area and a focusing level to a screen, determining the focusing area according to a motion of touching the screen, determining the focusing level according to the motion of touching the screen, and performing focusing on the focusing area according to the determined focusing level.

In accordance with another aspect of the present invention, an apparatus for manual focusing in a portable terminal is provided. The apparatus includes a display unit for providing a user interface to determine a focusing area and a focusing level, a touch sensor for recognizing a motion of touching the display unit, a controller for determining the focusing area and the focusing level according to the motion of touching the display unit, and a camera for performing focusing on the focusing area according to the determined focusing level.

In accordance with another aspect of the present invention, a method of providing focus control for a camera of a portable terminal is provided. The method includes presenting a preview image corresponding to an image currently observed by the camera, presenting a user interface for manually determining a focus area, upon receiving a manual focus command, determining a manual focusing area of the camera based on input received from a user via the user interface, adjusting a focus of the camera according to the determined manual focusing area, and capturing an image based on the adjusted focus.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a structure of a portable terminal according to an exemplary embodiment of the present invention; and

FIG. 2 is a flowchart illustrating a process of performing manual focusing by using a touch screen in a portable terminal according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention described hereinafter relate to a method and apparatus for performing manual focusing a touch screen in a portable terminal.

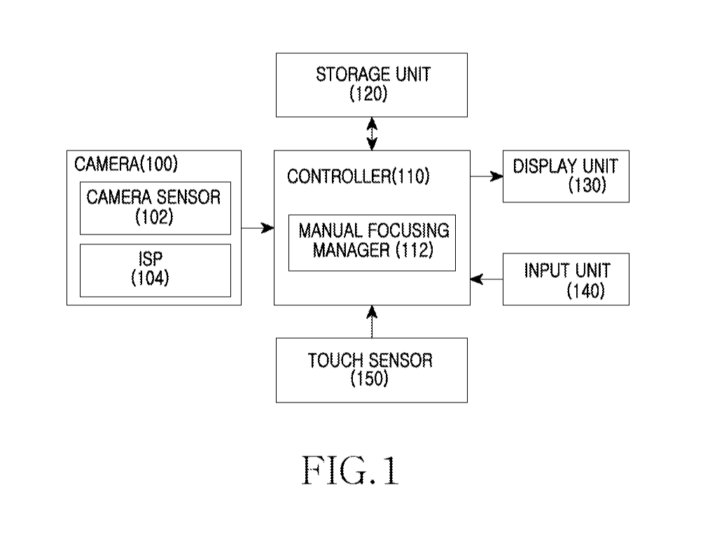

FIG. 1 is a block diagram illustrating a structure of a portable terminal according to an exemplary embodiment of the present invention.

Referring to FIG. 1, the portable terminal includes a camera 100, a controller 110, a storage unit 120, a display unit 130, an input unit 140, and a touch sensor 150. The portable terminal may also include additional units not shown. Similarly, the functionality of two or more of the above units may be integrated into a single component.

The camera 100 includes a camera sensor 102 and an Image Signal Processor (ISP) 104. The camera sensor 102 converts an optical signal, which is sensed when an image is captured, into an analog electrical signal. The ISP 104 converts the analog electrical signal from the camera sensor into digital data. The ISP 104 adjusts a focus when taking a photo, determines a target window for showing an area to be focused according to a coordinate input from the controller 110, and when the target window is determined, reports the completion of target window determination to the controller 110. Thereafter, the ISP 104 adjusts the focus according to a focusing level input from the controller 110.

The controller 110 controls and processes overall operation of the portable terminal. As shown in FIG. 1, the controller 110 may include a manual focusing manager 112 to control and process a function for providing a user interface for manual focusing on a screen of the display unit 130, for determining a focusing area and/or a focusing level by recognizing a motion of touching a screen by a user using the touch sensor 150, and thus for performing focusing according to the determination result. The user interface for manual focusing may include an interface including a tool by which the focusing area and the focusing level may be determined through a touch and a drag.

Upon detecting the generation of an event for determining the focusing area using the touch sensor 150, the manual focusing manager 112 may display the user interface capable of determining the focusing area on the screen of the display unit 130. Upon detecting the determination of the focusing area selected by the user via the touch sensor 150, the manual focusing manager 112 provides a coordinate corresponding to the determined focusing area to the ISP 104 to request to determine the focusing area. Thereafter, upon receiving from the ISP 104 a signal announcing that the focusing area is determined, the manual focusing manager 112 may display an icon (e.g., a jog dial) for determining the focusing level to the user interface. The manual focusing manager 112 determines the focusing level by recognizing a way of touching the icon (i.e., a touch direction, a touch count, a touch pattern, etc.) using coordinate data provided from the touch sensor 150, and provides the determined focusing level to the ISP 104.

The storage unit 120 stores a variety of programs and data for an overall operation of the portable terminal. According to an exemplary embodiment of the present invention, the storage unit 120 stores a program for determining the focusing area and the focusing level.

The display unit 130 displays a variety of information and state information generated while the portable terminal operates. In particular, the display unit 130 displays the user interface for determining the focusing area and/or the focusing level to the screen under the control of the manual focusing manager 112. In addition, the display unit 130 displays the focusing area and/or the focusing level determined through the user interface.

The input unit 140 employs a plurality of function keys to provide the controller 110 with data of a key input corresponding to a key pressed by the user. The touch sensor 150 recognizes a motion of touching the screen of the display unit 130 and provides the controller 110 with a coordinate corresponding to a touched point.

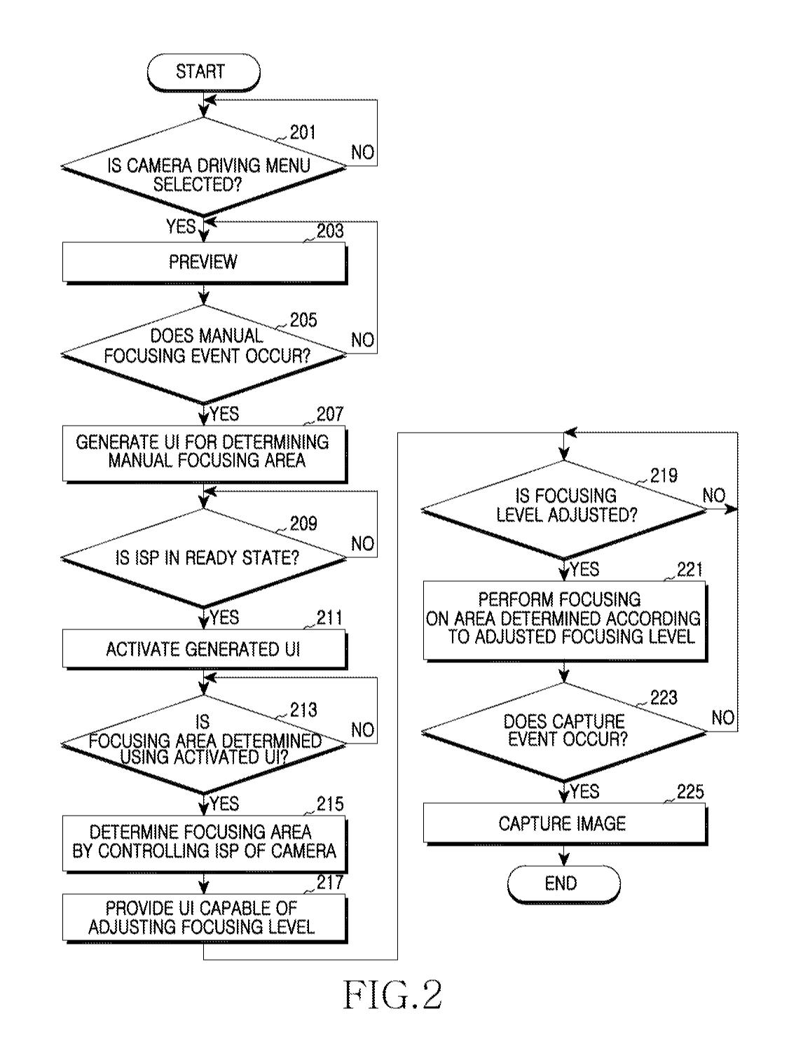

FIG. 2 is a flowchart illustrating a process of performing manual focusing by using a touch screen in a portable terminal according to an exemplary embodiment of the present invention.

Referring to FIG. 2, the portable terminal evaluates whether a camera driving menu is selected in step 201. If the camera driving menu is selected, proceeding to step 203, the portable terminal performs a preview function for displaying an image signal input from a camera sensor to the screen.

In step 205, the portable terminal evaluates whether a manual focusing event occurs. For example, the portable terminal evaluates whether the screen is touched while the preview function is performed or whether a menu for performing manual focusing is selected. When the manual focusing event occurs, proceeding to step 207, the portable terminal generates a user interface for determining a manual focusing area. The user interface for determining the manual focusing area includes an interface that includes a tool capable of designating a specific area on the screen through a touch or a drag. In this case, the portable terminal maintains the user interface in an inactive state, and thereafter transmits a command signal for the manual focusing to an ISP for performing a function of adjusting a focus so that the ISP enters a ready state. The inactive state of the user interface may be a state where the generated user interface is displayed on the screen but is unusable by the user, or a state where the generated user interface is not displayed on the screen.

In step 209, the portable terminal evaluates whether the ISP enters the ready state. If the portable terminal determines that the ISP has entered the ready state, the portable terminal activates the generated user interface in step 211.

In step 213, the portable terminal evaluates whether the focusing area is determined by using the activated user interface. The portable terminal evaluates whether a touch and a drag are generated on the screen by the user to designate a specific area which is to be determined as the focusing area. When the focusing area is determined, proceeding to step 215, the portable terminal controls the ISP to determine an area in which camera focusing is to be performed in practice according to the focusing area determined in the screen.

In step 217, the portable terminal provides a user interface capable of adjusting a focusing level. For example, the portable terminal displays a virtual jog dial capable of adjusting the focusing level to the screen. In step 219, the portable terminal evaluates whether the focusing level is adjusted by using the user interface. For example, the portable terminal determines whether the virtual jog dial is touched in an up/down direction and/or in a left/right direction. When the focusing level is adjusted using the user interface, proceeding to step 221, the portable terminal performs focusing on the determined focusing area according to the focusing level adjusted by using the user interface.

In step 223, the portable terminal evaluates whether a capture event occurs. In this case, the capture event may occur through a screen touch using the user interface and/or through a hardware key. If the capture event does not occur, the procedure returns to step 219. Otherwise, if the capture event occurs, proceeding to step 225, the portable terminal captures an image input from the camera in a state where focusing is achieved with the adjusted focusing level. Thereafter, the procedure of FIG. 2 ends.

In the aforementioned description, the user may control the portable terminal to switch to an auto-focusing mode at any time. In addition, in a development stage of a portable terminal implementing exemplary embodiments of the present invention, a tuning process may be used to improve a response speed of a screen having a touch sensor and for a focusing speed of the ISP.

According to exemplary embodiments of the present invention, a portable terminal provides a user interface capable of determining a focusing area and a focusing level through a touch screen. Therefore, there is an advantage in that a desired image may be obtained by determining a focusing area and/or level in a manner convenient to the user.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of manual focusing in a portable terminal, the method comprising:
providing a user interface for determining a focusing area and a focusing level to a screen;
determining the focusing area according to a motion of touching the screen;
determining the focusing level according to the motion of touching the screen; and
performing focusing on the determined focusing area according to the determined focusing level.

2. The method of claim 1, wherein the determining of the focusing area according to the motion of touching the screen comprises:
recognizing a coordinate in the screen touched by a user; and
determining the focusing area corresponding to the coordinate.

3. The method of claim 1, wherein the determining of the focusing level according to the motion of touching the screen comprises determining the focusing level using at least one of a touch direction, a touch count, and a touch pattern when the screen is touched.

4. The method of claim 1, wherein the user interface comprises a virtual jog dial for adjusting the focusing level.

5. An apparatus for manual focusing in a portable terminal, the apparatus comprising:
a display unit for providing a user interface to determine a focusing area and a focusing level;
a touch sensor for recognizing a motion of touching the display unit;
a controller for determining the focusing area and the focusing level according to the motion of touching the display unit; and
a camera for performing focusing on the determined focusing area according to the determined focusing level.

6. The apparatus of claim 5, wherein the controller receives a coordinate depending on the motion of touching the display unit from the touch sensor and determines the focusing area corresponding to the coordinate.

7. The apparatus of claim 5, wherein the controller receives a coordinate depending on the motion of touching the display unit from the touch sensor and determines the focusing level based on at least one of a touch direction, a touch count, and a touch pattern when the display unit is touched.

8. The apparatus of claim 5, wherein the user interface comprises a virtual jog dial for adjusting the focusing level.

9. The apparatus of claim 5, wherein the camera comprises:
a camera sensor for capturing an optical signal corresponding to an image and converting the optical signal into an analog signal; and
an Image Signal Processor (ISP) for converting the analog signal into a digital signal.

10. The apparatus of claim 5, wherein the controller comprises:
a manual focusing manager for providing a user interface through which a user may control the focusing area and the focusing level.

11. The apparatus of claim 5, wherein the camera is not a primary function of the portable terminal.

12. A method of providing focus control for a camera of a portable terminal, the method comprising:
presenting a preview image corresponding to an image currently observed by the camera;
presenting a user interface for manually determining a focus area, upon receiving a manual focus command;
determining a manual focusing area of the camera based on input received from a user via the user interface;
adjusting a focus of the camera according to the determined manual focusing area; and
capturing an image based on the adjusted focus.

13. The method of claim 12, further comprising:
presenting a focusing level user interface for manually determining a focusing level; and
determining a focusing level based on input received from the user via the focusing level,
wherein the adjusting of the focus comprises adjusting the focus of the camera according to the determined manual focusing area and the determined focusing level.
